(19) United States
(12) Patent Application Publication
(10) Pub. No.: US 2024/0091731 A1
(43) Pub. Date: Mar. 21, 2024

(54) DEVICES AND METHODS FOR MULTIPLEXING CHEMICAL SYNTHESIS

(71) Applicant: LC Sciences, Houston, TX (US)

(72) Inventors: Xiaochuan Zhao, Houston, TX (US); Xiaolin Zhang, Houston, TX (US)

(21) Appl. No.: 17/768,066

(22) PCT Filed: Apr. 19, 2021
(86) PCT No.: PCT/US2021/027960

§ 371 Date: Apr. 11, 2022

Related U.S. Application Data
(60) Provisional application No. 63/012,415, filed on Apr. 20, 2020.

(51) Int. Cl. B01J 19/00; B33Y 10/00; B33Y 30/00

(52) U.S. Cl. CPC B01J 19/0046; B33Y 10/00; B33Y 30/00; B01J 2219/00585; B01J 2219/00599; B01J 2219/00621; B01J 2219/00623; B01J 2219/00664; B01J 2219/00675; B01J 2219/00711; B01J 2219/00722

(57) ABSTRACT

The present invention relates to the field of chemical synthesis. Specifically, the present invention relates to methods, materials, compositions, and devices for multiplexing chemical synthesis. In particular, the present invention provides novel methods, materials, compositions, and devices to synthesize plurality of chemical compounds, including but not limited to nucleic acids, peptides, saccharides, and phospholipids. Specifically, the present invention provides methods, materials, compositions, and devices to first form plurality of isolated wells on a solid substrate and then to carry out plurality of chemical reactions in the isolated wells, in parallel, and on the same substrate.

### RELATED APPLICATIONS

This application claims priority to U.S. Ser. No. 63/012,415 filed on Apr. 20, 2020.

### FIELD OF INVENTION

The present invention relates to the field of chemical synthesis. Specifically, the present invention relates to methods, materials, compositions, and devices for multiplexing chemical synthesis. In particular, the present invention provides novel methods, materials, compositions, and devices to synthesize plurality of chemical compounds, including but not limited to nucleic acids, peptides, saccharides, and phospholipids. Specifically, the present invention provides methods, materials, compositions, and devices to first form plurality of isolated wells on a solid substrate and then to carry out plurality of chemical reactions in the isolated wells, in parallel, and on the same substrate.

### BACKGROUND

High-throughput, high-quality, and low-cost synthesis of biomolecules, such as nucleic acids, peptides, saccharides, and phospholipids is critical in many biological, biomedical, agricultural research and applications, such as genome studies, gene assembly, gene function studies, gene modifications, gene profiling, drug development, disease diagnosis, personal medicine, and forensic tests. In the last couple of decades, many advances have been made in the development of high-throughput synthesis technologies. However, most of the existing technologies suffer one way or another from scalability, flexibility, accuracy, and cost.

This invention relates to parallel synthesis of plurality of biomolecules on a solid substrate.

Early applications of parallel synthesis technologies were mostly focused on in situ synthesis of DNA microarray chips for on-chip gene expression, mutation, and pathogen detections (Lockhart et al. Expression monitoring by hybridization to high-density oligonucleotide arrays, Nature Biotech. 14, 1675-1680 (1996); de Saizieu et al. Bacterial transcript imaging by hybridization of total RNA to oligonucleotide arrays. Nature Biotech. 16, 45-48 (1998); Drmanc et al. Accurate sequencing by hybridization for DNA diagnostics and individual genomics. Nature Biotech. 16, 54-58 (1998)).

By early 2000s, the oligo DNA molecules synthesized on and cleaved from the surface of microfluidic microarray chips were successfully applied in off-chip parallel assembly of multiple genes (Zhou, X. et al. Microfluidic picoarray synthesis of oligodeoxynucleotides and simultaneously assembling of multiple DNA sequences. Nucleic Acids Research 32, 5409-5417 (2004); Tian, J. et al. Accurate multiplex gene synthesis from programmable DNA chips. Nature 432, 1050-1054 (2004)). Since then, many other off-chip applications have been demonstrated, including small interfering RNA (siRNA) library preparation (Dahlgren, C. et al. Analysis of siRNA specificity on targets with double-nucleotide mismatches. Nucleic Acid Research 36 e53 (2008)); sequence capture for targeted sequencing (Gnirke, A. et al. Solution hybrid selection with ultra-long oligonucleotides for massively parallel targeted sequencing, Nature Biotech. 27, 182-189 (2009)); CRISPR/Cas9 guide RNA library preparation (Malina, A. et. al., Adapting CRISPR/Cas9 for functional genomics screens. Methods Enzymol 546, 193-213 (2014)); protein coding and antibody library preparation (Xu, M. et al., Design and construction of small perturbation mutagenesis libraries for antibody affinity maturation using massive microchip-synthesized oligonucleotides. Journal of Biotechnology 194, 27-36 (2015)); and FISH application (Schmidt, T. L. et. al. Scalable amplification of strand subsets from chip-synthesized oligonucleotide libraries. Nature Commun. 6, 8634 (2015)). As compared to on-chip applications, these off-chip applications demand for further improvement in synthesis quality, synthesis length, quantity scalability, and production cost.

One method of the parallel on-chip DNA synthesis uses conventional phosphoramidite chemistry (Beaucage, S. L. et. al. Deoxynucleoside phosphoramidites—a new class of key intermediates for deoxypolynucleotide synthesis. Tetrahedron Lett. 22, 1859-1862 (1981)). Inkjets are used to deliver phosphoramidite monomers of different nucleotides to predetermined locations of a solid substrate in a stepwise fashion to synthesize predetermined DNA sequences on the corresponding surface areas. Two types of substrates have been used. The first type is a flat glass plate. In each synthesis cycle a droplet array of various monomers are printed by the inkjets on the plate to add one base to each corresponding DNA sequence. This substrate has primarily been used to make DNA microarrays for on-chip hybridization applications (Hughes, T. R. et. al., Expression profiling using microarrays fabricated by an ink-jet oligonucleotide synthesizer. Nat. Biotechnol., 19, 342-347 (2001)). The DNA molecules on the flat glass plate DNA microarrays have also been cleaved off for off-chip applications (Gnirke, A. et al. Solution hybrid selection with ultra-long oligonucleotides for massively parallel targeted sequencing, Nature Biotech. 27, 182-189 (2009)). However, it is challenging to produce high purity DNA sequences on the flat glass plates. It is difficult to produce identical droplet shapes in all synthesis cycles. Consequently, the DNA compositions produced on droplet peripheral regions tend to be mixtures of variety of unintended or impurity sequences. To produce high purity DNA sequences another substrate type has been developed. This type of substrate is made of silicon wafers, has 3-deminsional structures, and is produced by microelectronic or micro-electro-mechanical system fabrication processes (Banyai, W. et. al., Devices and methods for oligonucleic acid library synthesis, US20160310927 A1 (2016)). In the 3-demintional structures plurality of active surface areas are isolated by inactive surface areas in such a way that the monomer solution droplets delivered by individual inkjets would completely cover and/or flow over the individual active surface areas while cross flow of the monomer solution between distinct active surface areas is prevented. DNA molecules would be synthesized only on the active surface areas and not on the inactive surface areas.

Another method of the parallel on-chip synthesis of DNA and other biopolymer molecules uses conventional synthesis chemistries that involve monomers having acid or base labile protecting groups. The uniqueness of the method is the use of photogenerated acids or bases in solution phase to deprotect the monomers. This makes it possible to use projected light or light beams to activate the synthesis at the desired locations of corresponding substrates. The method and related devices have been described in detailed in Gao, X. et. al., Method and apparatus for chemical and biochemical reactions using photogenerated reagents, U.S. Pat. No. 6,426,184 B1 (2002); Zhou, X., et. al., Fluidic methods and devices for parallel chemical reactions, WO 02/02227 A2 (2002); and Gulari, E. et. al., Method for forming molecular sequences on surfaces, US2007/0224616 A1 (2007) which are hereby incorporated by reference in their entirety. One aspect of the method is the confinement of the photogenerated reagents in solution phase. 3-dimensional barriers and/or microfluidic chambers are used to retain the photogenerated reagents in the light illuminated areas long enough to complete the deprotection of propagating DNA or other biopolymer molecules. The same light directed synthesis chemistry has been demonstrated in producing DNA arrays on flat glass substrates (Gulari, E. et. al., Method for forming molecular sequences on surfaces, US2007/0224616 A1 (2007)). Scavenging reagents are added to the reaction solution to neutralize and/or limit the diffusion of the photogenerated acid or base molecules. This method does not eliminate concentration gradient of the active acid or base in the peripheral regions of individual synthesis features which are defined by corresponding light patterns. Consequently, impurity sequences are inevitably produced in the peripheral regions. As comparison, a physical 3-deminsional barrier on a substrate can completely block the near surface lateral flow or diffusion of the photogenerated active reagents and is desirable for producing high quality sequences especially for off-chip applications.

The 3-dimensional structures used in both above methods are produced on glass plates and silicon wafers using microelectronic or micro-electro-mechanical system fabrication processes. The fabrication requires expensive materials, equipment, and clean-room facilities. Additionally, before the start of a synthesis process one needs to align the prefabricated 3-dimensional structures to the corresponding inkjet printing and/or optical projection system. This involves additional instrumentations and operation steps.

There is a genuine need for the development of chemical methods and synthesis apparatus to combine 3-deminsional barrier construction and biomolecule synthesis into an integrated process that is simple, versatile, cost-effective, easy to operate, and can produce biopolymer arrays of improved purity.

### BRIEF DESCRIPTION OF THE DRAWINGS

FIG. 1 schematically illustrates basic steps involved in the light directed parallel synthesis process of this invention.

FIG. 2A illustrates the front view of an exemplary microwell plate of this invention. The microwells are formed by barrier grids.

FIG. 2B illustrates the A-A section view of FIG. 2A.

FIG. 2C illustrates a detailed view of area B of FIG. 2B.

FIG. 2D illustrates a perspective view of the microwell plate of FIG. 2A.

FIG. 3A illustrates the front view of another exemplary microwell plate of this invention. The microwells are formed by square-shaped barriers.

FIG. 3B illustrates the A-A section view of FIG. 3A.

FIG. 3C illustrates a perspective view of the microwell plate of FIG. 3A.

FIG. 4A illustrates the front view of another exemplary microwell plate of this invention. The microwells are formed by circular barriers.

FIG. 4B illustrates the A-A section view of FIG. 4A.

FIG. 5A illustrates the front view of another exemplary microwell plate of this invention. The microwells are formed by ridge-shaped barrier grids.

FIG. 5B illustrates the A-A section view of FIG. 5A.

FIG. 5C illustrates a detailed view of area B of FIG. 5B.

FIG. 5D illustrates a perspective view of the microwell plate of FIG. 5A.

FIG. 6A illustrates the front view of another exemplary microwell plate of this invention. The microwells are formed by ridge-shaped barrier grids. Inside each microwell there is a thin film extending out at the foot of the barrier.

FIG. 6B illustrates the A-A section view of FIG. 6A.

FIG. 6C illustrates a detailed view of area B of FIG. 6B.

FIG. 6D illustrates a perspective view of the microwell plate of FIG. 6A.

FIG. 7 illustrates the front view of another exemplary microwell plate of this invention. In this exemplary embodiment, the complete microwell assembly consists of 24 microwell subassemblies or subarrays.

FIG. 8 schematically illustrates chemical compositions and reactions inside reaction microwells.

FIG. 9 schematically illustrates a synthesis apparatus using light projector.

FIG. 10A schematically illustrates an exemplary utilization of through-hole titer plate to isolate subarrays for post-synthesis processes. The figure shows a perspective view of a through-hole titer plate and a matching microwell assembly plate.

FIG. 10B shows a cross-section view of FIG. 10A.

FIG. 10C shows a cross-section view of the devices of FIG. 10A after the through-hole titer plate is pressed against and the matching microwell assembly plate.

FIG. 10D illustrates a detailed view of area A of FIG. 10C.

FIG. 11 presents the stereomicroscopic image of a microwell plate fabricated in Experiment 1.

FIG. 12 presents fluorescence image of a microwell plate after light directed nucleotide synthesis of Experiment 1.

### DEFINITIONS

Term “barrier” and “reaction barrier” refer to a solid or gel-like structure placed on a solid substrate and serving the purpose of preventing or substantially preventing liquid phase molecules from moving across the structure.

Term “photopolymerization” refers to a photochemical reaction process in which monomer and/or oligomer molecules are polymerized and/or crosslinked upon exposure to light. The reaction results in the formation of polymer materials.

Term “photopolymer” refers to a material produced by a photopolymerization reaction. In the scope of this description, photopolymer is produced in a 3D printing process and is used as the construction material for barriers.

Term “material swelling” refers to the volume increase of a material when it is immersed in a solvent. The degree of the swelling is measured by the ratio of the volume increase and the original material volume.

Term “wells”, “reaction wells”, “microwells”, “reaction zones”, “isolated areas”, “isolated volumes”, “isolated cells” and their derivatives refer to a space bounded, surrounded, or partially surrounded by barriers.

Terms “substrate” and “substrate surface” refer to in one aspect refer to object surface that interacts with chemical, and/or biochemical molecules to form a new, modified, or functionalized surface having certain chemical, biochemical, or physical properties. In another aspect, the “substrate” and “substrate surface” refer to the modified or functionalized surface that can interact with certain in-coming molecules and form linkages or conjugates with the molecules.

Terms “biomolecules”, “synthetic biomolecules”, “synthetic molecules”, “synthesized molecules”, “synthesized product” and their derivatives refer to the molecules or products produced by the parallel synthesis processes described in this disclosure.

Term “photoinitiator” refers to a molecule that creates reactive species when exposed to light radiation. Depending the molecular formula of the photoinitiator, the produced reactive species are radicals, cations, anions, or ionic radicals. For the applications in this invention, the photoinitiators for radicals are used in the barrier forming photopolymerization; the photoinitiators for cations or cation radicals are used to produce photoacids in parallel synthesis of DNA, peptide, and other biomolecules that involve acid label protection groups; the photoinitiators for anions and anion radicals are used to produce photobases in parallel synthesis of peptide, and other biomolecules that involve base label protection groups.

Term “photosensitizer” refers to a molecule that produces a chemical change in another molecule in a photochemical process. For the applications of this invention, the photosensitizer is used to activate a photoinitiator at a longer wavelength than the intrinsic excitation wavelength of the photoinitiator and therefore to match wavelength of corresponding photochemical reaction with that of the available light projector.

Term “tube” refers to a vessel in which PCR or any other types of bimolecular reactions take place. The “tube” may be made of plastic and in form of micro tubes or Eppendorf tubes. The “tube” may also be made of glass, silicone, silicon, and metals and be a part of microfabricated devices.

Terms “target”, “target sequence”, and their derivatives refer to any single or double-stranded nucleic acid sequence that is suspected or expected to be present in a sample and is designated to be selected, analyzed, examined, probed, captured, replicated, synthesized, and/or amplified using any appropriate methods.

Term “sample” refers to any specimen, culture and the like that is suspected of including a target. The sample can include any biological, clinical, surgical, agricultural, atmospheric or aquatic-based specimen containing one or more nucleic acids. The term also includes any isolated nucleic acid sample such as genomic DNA from fresh-frozen or formalin-fixed paraffin-embedded tissues.

Term “hybridization” is consistent with its use in the art, and generally refers to the process whereby two nucleic acid molecules undergo base pairing interactions. Two nucleic acid molecules are said to be hybridized when any portion of one nucleic acid molecule is base pared with any portion of the other nucleic acid molecule; it is not necessarily required that the two nucleic acid molecules be hybridized across their entire respective lengths and in some embodiments, at least one of the nucleic acid molecules can include portions that are not hybridized to the other nucleic acid molecule.

### SUMMARY

The object of the present invention is to provide a new and improved parallel synthesis method that has improved scalability, product purity, and low production cost. Specifically, the present invention provides methods, materials, compositions, and devices to first form plurality of isolated cells on a solid substrate and then to carry out plurality of chemical reactions in the isolated cells, in parallel, and on the same substrate.

The present invention relates to methods of parallel chemical synthesis on a solid surface by forming barrier structures on a solid surface by photopolymerization and conducting chemical synthesis in the barrier confined regions of the solid surface.

The present invention relates to devices and apparatus for performing parallel chemical synthesis on a solid surface where the apparatus comprises a solid substrate as the carrier of in-situ barrier construction and biomolecule synthesis, a reagent manifold for the delivery of 3D printing resins and synthesis reagents, a projector, and a computer control system. The reaction apparatus of the present invention may further comprise a reactor cartridge that contains a vibration generator.

### DETAILED DESCRIPTION

### Approach

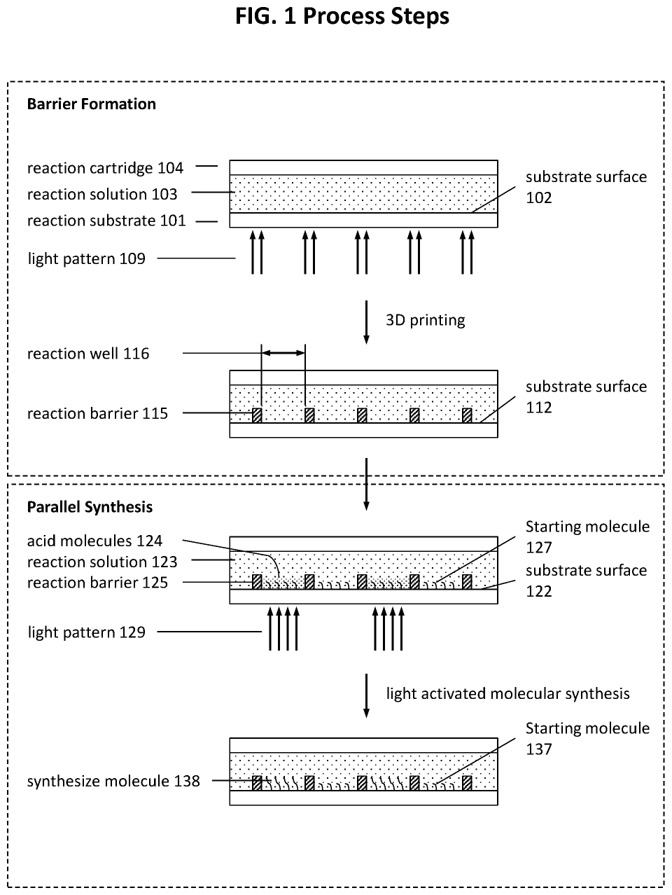

FIG. 1 schematically illustrates the light directed parallel synthesis of this invention. The process is divided into barrier formation and parallel synthesis sections, respectively. One novel aspect of this invention is the in-situ formation of reaction barriers that is performed in the same reaction apparatus system with the parallel synthesis. Reaction barriers 115 are formed by 3D printing. As an exemplary embodiment, the 3D printing shown in FIG. 1 is based on photopolymerization (Bagheri, A. et. al., Photopolymerization in 3D Printing, ACS Appl. Polym. Mater. 1, 593-611 (2019)). A reactor comprises a transparent reaction substrate 101 and a reaction cartridge 104. To form the reaction barriers 115, a reaction solution 103 is sent into the reactor. The reaction solution 103 contains photopolymerization resin. Light pattern 109 is projected to the substrate surface 102 to cause photopolymerization reaction to take place on and near the substrate surface 102 forming reaction barriers 115. The volumes above the substrate surface 112 and surrounded by the reaction barriers 115 become reaction wells 116. Then the parallel synthesis proceeds in the same reactor and on the same apparatus. In the synthesis process, individual reaction solutions 123 are sequentially sent into the reactor. As an exemplary embodiment, substrate surface 122 is first attached with starting molecules 127 that are protected by acid labile protecting groups. These starting molecules 127 are not reactive until the protecting groups are removed by an acid solution. To activate the starting molecules 127 in specific reaction wells on the substrate surface 122, a deblock reaction solution 123 containing a photoacid generator (PAG) is sent into the reactor. The photoacid generator is a neutral molecule in its natural state and without being exposed to light. A light pattern 129 is projected to the substrate surface 122. The light pattern 129 illuminates specific reaction wells. The light exposed photoacid generator produces acid molecules 124 which in turn remove the protecting groups from the starting molecules 127 inside the specific reaction wells. The reaction barriers 125 prevent the lateral diffusion of the acid molecules 124 near the substrate surface 122 therefore prevent the acid molecules from activating the starting molecules inside the unexposed reaction wells. The deblock reaction solution 123 is then washed away by a wash solution. A monomer reaction solution 123 containing reactive monomer molecules is sent into the reactor. The reactive monomer molecules react only with the activated starting molecules 127 and form synthesis product 138 inside the light exposed reaction wells. The sizes, materials, compositions, devices, apparatus, and the relations of the various processes of the disclosed method will become clear as the individual processes and applications of the method are described.

### Reaction Barrier

Reaction barrier of this invention is a solid or gel-like structure that is placed on a solid substrate to serve the purpose of preventing or substantially preventing liquid phase molecules from moving across the structure.

In some embodiment, the reaction substrate is made of a transparent material. The transparent material includes but not limited to glass, quartz, plastic, polymer, and composite. The plastic material is selected from a group consisting of polycarbonate, polystyrene, polymethylmethacrylate, cellulose acetate butyrate, and any other appropriate materials. In some embodiment, the composite material is made of a plastic base coated and/or laminated with a chemical resistant material including but not limited to glass, silicon dioxide, and silicon-based sol gel. In some other embodiment, the reaction substrate is made of a semitransparent or an opaque material including but not limited to silicon, metal, ceramic, and plastic.

In some embodiment, substrate surface, on which barriers are constructed, is derivatized with linker molecules that form covalent bond or have strong affinity with photopolymer molecules. The chemical composition of the linker molecules is determined by the chemical compositions of the substrate surface and the photopolymer molecules. In an exemplary embodiment, glass is used as the substrate and methacrylate is used as monomer for photopolymerization. A silane compound (3-methacrylamidopropyl) triethoxysilane is used as the linker. This molecule covalently binds to the glass substrate through a condensation reaction between the linker triethoxysilane group and the glass siliceous surface. The methacrylic group of the immobilized linker participates in the radical chain reaction and covalently joins with or links to the barrier structures formed in the photopolymerization reaction of the methacrylate monomers. In some embodiments more than one types of linker molecules are used in the surface derivatization. In additional to the linker molecules to link the barrier materials with the substrate surface, another linker molecule is added to provide initiation groups in the parallel synthesis of biomolecules. For parallel DNA synthesis, the initiation group can be either hydroxyl (—OH) group or amine (—NH₂) group. For parallel peptide synthesis, the initiation group can be amine group. Exemplary second linker molecules include but not limited to N-(3-triethoxysilylpropyl)-4-hydroxybutyramide and 3-aminopropyltrimethoxysilane for —OH and —HN₂ initiation groups, respectively. The selection of appropriate linker molecules is well known to those skilled in the field of surface chemistry. For description purpose, we call the photopolymer binding linker the first linker and the biomolecule synthesis initiating linker the second linker. The ratio between the first linker and the second linker is adjusted in such a way that the barrier materials remain attached to the substrate surface throughout the whole parallel synthesis process and at the same time an adequate surface density of biomolecule synthesis initiation linker is provided. An adequate surface density of the initiation linkers is to provide the highest possible surface product density and at the same time to minimize the negative effect to the synthesis yield as the length of the synthetic molecules increases due to intermolecular steric hindrance. The experimental determination of the adequate surface density of the initiation linker is well known to those skilled in the field of solid phase synthesis of DNA, RNA, peptide, and other biomolecules. In one embodiment, the ratio between the first linker and the second linker is between 0.0001 and 10000. In another embodiment, the ratio between the first linker and the second linker is between 0.001 and 10000. In another embodiment, the ratio between the first linker and the second linker is between 0.01 and 10000. In another embodiment, the ratio between the first linker and the second linker is between 0.1 and 10000. In another embodiment, the ratio between the first linker and the second linker is between 1 and 10000. In another embodiment, the ratio between the first linker and the second linker is between 10 and 10000. In another embodiment, the ratio between the first linker and the second linker is between 100 and 1000.

The barriers can be made of various materials and formed through various photopolymerization chemistries. The photopolymerization chemistries include but not limited to free radical reaction, cationic reaction, thio-ene or thio-yne reaction, and dual cure reaction. In some embodiments commercial 3D printing resins are used in the formation of barriers by photopolymerization. Exemplary commercial resin suppliers include but not limited to Liqcreate (Netherlands), MakerJuice Labs (US), Peopoly (China), PhotoCentric Inc. (US), Uniz (US), and Zortrax (Poland). In some embodiments the barrier materials are preferably organic solvent resistant. For example, DNA synthesis involves acetonitrile (ACN), dichloromethane (DCM), and tetrahydrofuran (THF). The barriers built for DNA synthesis preferably do not dissolve in these solvents. In some embodiment, certain degree of material swelling in solvents is acceptable. In some embodiment, the acceptable degree of material swelling is less than 5 percent. In some embodiment, the acceptable degree of material swelling is less than 10 percent. In some embodiment, the acceptable degree of material swelling is less than 50 percent. In some embodiment, the acceptable degree of material swelling is less than 100 percent. In some embodiment, the acceptable degree of material swelling is less than 200 percent. The material swelling is controlled by the material composition, the solvent type, and the cross-linking density of the polymer material. The selection of appropriate polymerization chemistries and materials are well known to those in the fields of polymer science, material science, and 3D printing technologies (Bagheri, A. et. al., Photopolymerization in 3D Printing, ACS Appl. Polym. Mater. 1, 593-611 (2019)).

The above mentioned photopolymerization reactions can be performed under the light exposure of various wavelengths depending on the photoinitiators and/or photosensitizers used in the printing resin compositions. In one embodiment, the wavelength is between 240 nm and 540 nm. In another embodiment, the wavelength is between 270 nm and 520 nm. In another embodiment, the wavelength is between 360 nm and 520 nm. In another embodiment, the wavelength is between 380 nm and 520 nm. In another embodiment, the wavelength is between 380 nm and 450 nm. In another embodiment, the wavelength is between 380 nm and 420 nm. In another embodiment, the wavelength is around 405 nm.

Some embodiments of this invention involve a surface modification process after the barriers are constructed and before parallel synthesis is started. The modification is applied to the exposed surface areas that are intended to be used for the synthesis of biomolecules. This surface modification process is to passivate the reactive groups that are used to link the barrier materials to the substrate surface. In an exemplary embodiment, the alkene groups in the first linker molecules are passivated through Michael addition reaction which opens the double bonds in the linker alkene groups and form more stable saturated bonds. In an exemplary embodiment, the barriers are constructed on a substrate surface that contains methacrylic group. After the barrier construction, the substrate surface is subjected to an ethanol reaction solution that contains n-butylamine and potassium ethoxide. The Michael addition reaction takes place between n-butylamine and methacrylic group under catalytic assistance of potassium ethoxide. The result is the opening of alkene bond and the addition of n-butylamine to the linker terminal. Other reactions, such as thio-ene reaction, can be used to remove remaining surface alkene groups as well. The Michael addition reaction is well known to those in the field of organic chemistry.

In some embodiment, substrate surface is derivatized with linker molecules that do not form covalent bond with photopolymer molecules. In some embodiment, the molecular structure, including molecular size and constituent functional groups, of the linker molecules is selected in such a way that the barrier structures adhere to the substrate surface throughout the parallel synthesis process but can be peeled off from the substrate surface in a post synthesis process. An exemplary post synthesis process is to use Scotch tape to peel the barrier structures off.

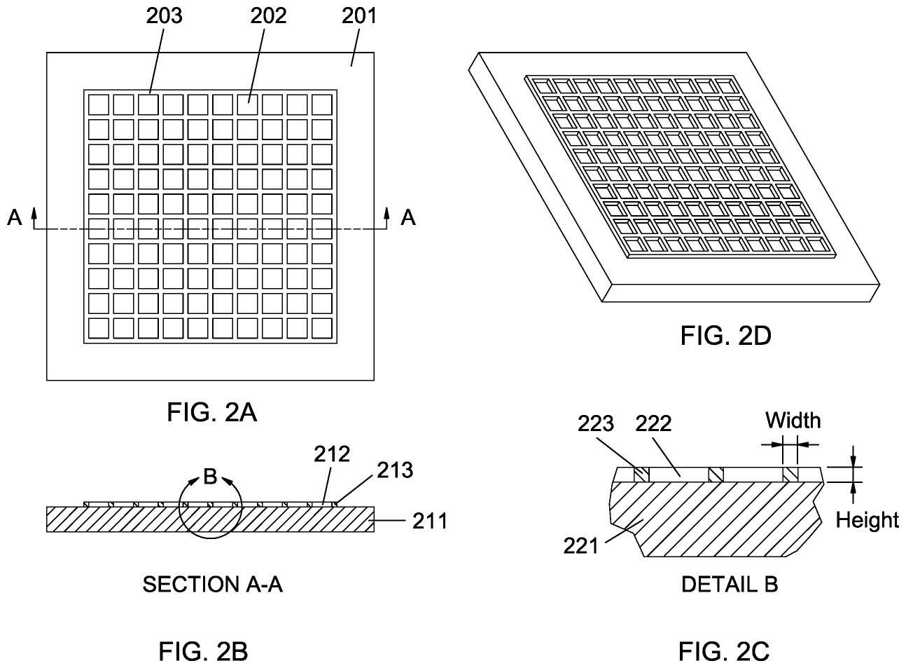

The reaction barriers can be made in various shapes and sizes depending on applications. FIG. 2A illustrates the front view of an exemplary microwell plate of this invention. The microwells 202 are formed by barrier grids 203 on a substrate 201. FIG. 2B illustrates the A-A section view of FIG. 2A. FIG. 2C illustrates a detailed view of area B of FIG. 2B. FIG. 2D illustrates a perspective view of the microwell plate of FIG. 2A. The barrier 223 width and height can be designed and made according to the need of corresponding applications. In some embodiment, the barrier 223 width is between 0.1 micrometer and 10,000 micrometers. In some embodiment, the barrier 223 width is between 1 micrometer and 10,000 micrometers. In some embodiment, the barrier 223 width is between 1 micrometer and 1,000 micrometers. In some embodiment, the barrier 223 width is between 1 micrometer and 100 micrometers. In some embodiment, the barrier 223 width is between 5 micrometers and 100 micrometers. In some embodiment, the barrier 223 width is between 10 micrometers and 100 micrometers. In some embodiment, the barrier 223 width is between 20 micrometers and 100 micrometers. In some embodiment, the barrier 223 width is between 20 micrometers and 50 micrometers. In some embodiment, the barrier 223 height is between 0.1 micrometer and 10,000 micrometers. In some embodiment, the barrier 223 height is between 1 micrometer and 10,000 micrometers. In some embodiment, the barrier 223 height is between 1 micrometer and 1,000 micrometers. In some embodiment, the barrier 223 height is between 1 micrometer and 100 micrometers. In some embodiment, the barrier 223 height is between 5 micrometers and 100 micrometers. In some embodiment, the barrier 223 height is between 10 micrometers and 100 micrometers. In some embodiment, the barrier 223 height is between 10 micrometers and 50 micrometers. The center-to-center distance of adjacent microwells 202, 212, 222 can be designed and made according to the need of corresponding applications. In some embodiment, the center-to-center distance is between 1 micrometer and 10,000 micrometers. In some embodiment, the center-to-center distance is between 5 micrometers and 10,000 micrometers. In some embodiment, the center-to-center distance is between 10 micrometers and 10,000 micrometers. In some embodiment, the center-to-center distance is between 50 micrometers and 10,000 micrometers. In some embodiment, the center-to-center distance is between 50 micrometers and 1,000 micrometers. In some embodiment, the center-to-center distance is between 50 micrometers and 200 micrometers.

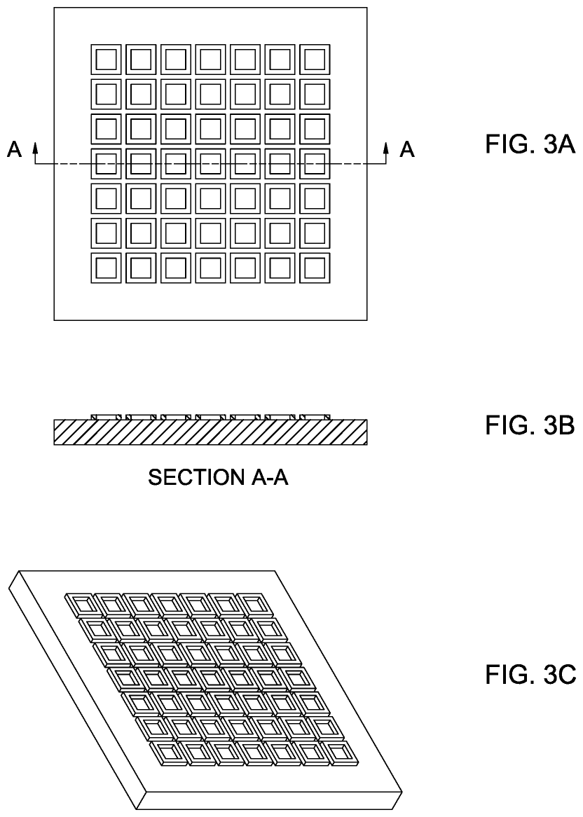

FIG. 3A illustrates the front view of another exemplary microwell plate of this invention. The microwells are formed by square-shaped barriers. FIG. 3B illustrates the A-A section view of FIG. 3A. FIG. 3C illustrates a perspective view of the microwell plate of FIG. 3A.

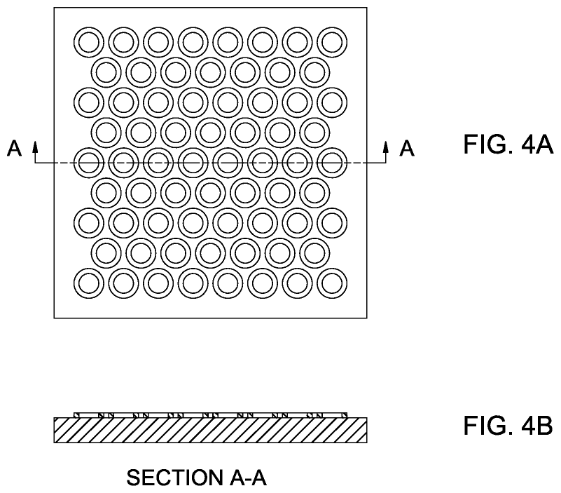

FIG. 4A illustrates the front view of another exemplary microwell plate of this invention. The microwells are formed by circular barriers. FIG. 4B illustrates the A-A section view of FIG. 4A.

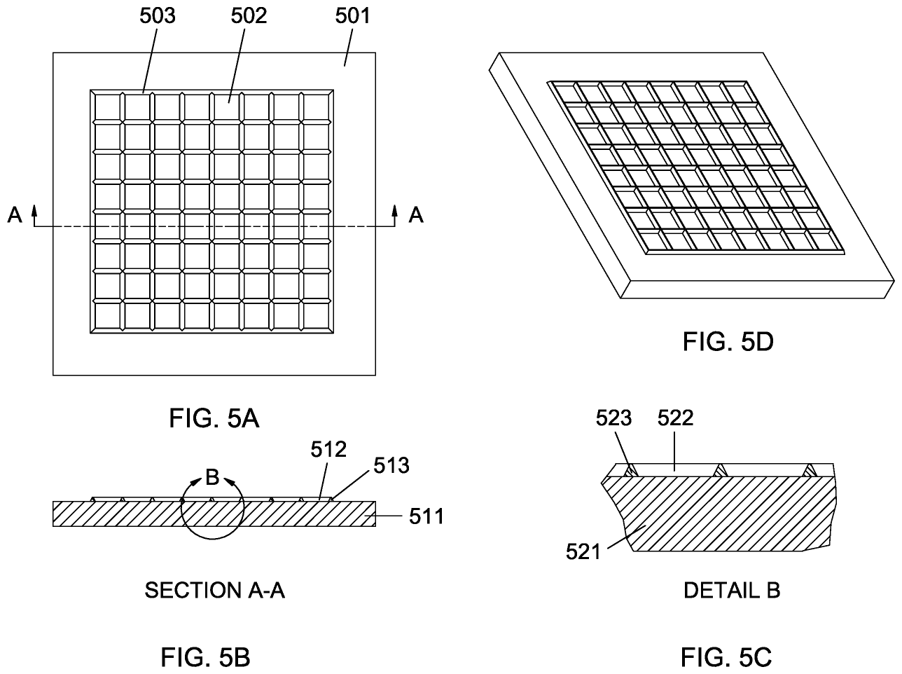

FIG. 5A illustrates the front view of another exemplary microwell plate of this invention. The microwells are formed by ridge-shaped barrier grids 503, 513, and 523. FIG. 5B illustrates the A-A section view of FIG. 5A. FIG. 5C illustrates a detailed view of area B of FIG. 5B. FIG. 5D illustrates a perspective view of the microwell plate of FIG. 5A. In some embodiments the ridge-shaped barrier cross-section 513 and 523 is created by setting an appropriate intensity profile of the illumination light pattern. In some embodiments the ridge-shaped barrier cross-section is created by setting an appropriate exposure time profile of the illumination light pattern.

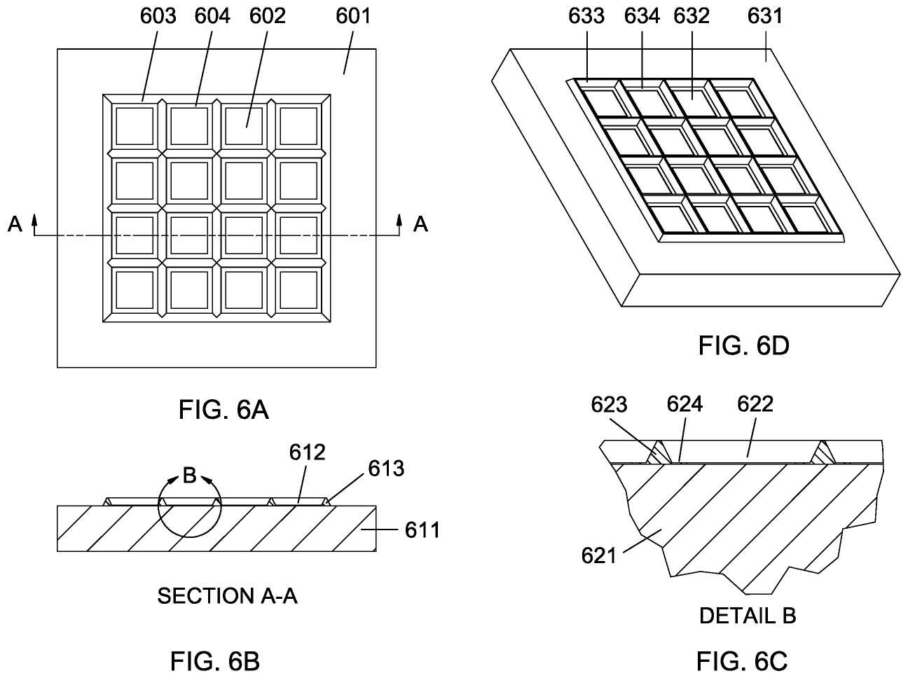

FIG. 6A illustrates the front view of another exemplary microwell plate of this invention. The microwells are formed by ridge-shaped barrier grids 603, 613, 623, and 633. Inside each microwell 602, 612, 622, and 632 there is a thin film or a skirt 604, 624, and 634 extending out at the foot of the barrier. FIG. 6B illustrates the A-A section view of FIG. 6A. FIG. 6C illustrates a detailed view of area B of FIG. 6B. FIG. 6D illustrates a perspective view of the microwell plate of FIG. 6A. Inside each microwell 602, 612, 622, and 632, fluid mixing or exchanging in the barrier foot corner regions may be less favorable than in the center regions. The skirt 604, 624, and 634 is designed to block the substrate surfaces near the barrier foot from being used to synthesize biomolecules.

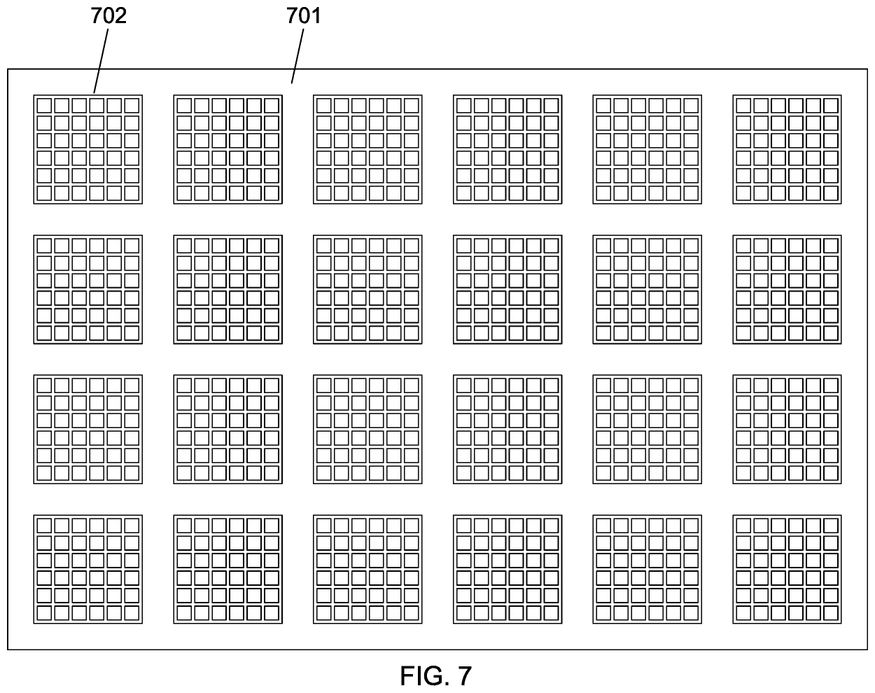

FIG. 7 illustrates the front view of another exemplary microwell plate of this invention. In this exemplary embodiment, the complete microwell assembly 701 consists of 24 microwell subassemblies or subarrays 702.

Obviously, many other variations of barrier size, shape, and arrangement can be designed and made in light of the above teachings to address fluid flow, fluid mixing, fluid isolation, biomolecule synthesis quality, post-synthesis assay, and other aspect of the fabrication, synthesis, and application processes.

### Parallel Synthesis

In the parallel synthesis process of this invention two or more biomolecules of different compositions or sequences are synthesized in parallel on a microwell plate with specific sequences being synthesized in specific microwells. In an exemplary embodiment, multiple DNA sequences are synthesized. The synthesis is accomplished by cyclic addition of nucleotides to the surface immobilized sequences starting from linker molecules. In each cycle, reaction solutions including wash solution, deblock solution, wash solution, monomer solution, wash solution, capping solution, wash solution, and oxidation solution are sent into a reactor sequentially. In an exemplary embodiment, the nucleotide monomers are phosphoramidites having dimethoxytrityl (DMT) protecting groups at 5′ terminals. The DMT protecting group prevents more than one nucleotide to be added to an immobilized sequence in one monomer coupling cycle. The DMT protecting group must be removed from an immobilized sequence before a new nucleotide can be added to the sequence. The DMT protecting group is acid labile. Some embodiments of this invention add photoacid generator (PAG) in deblock solution. PAG produces acid upon light exposure and enables parallel synthesis. A parallel synthesis cycle starts by sending a PAG-based deblock solution into the reactor to fill up all microwells 116 (FIG. 1). Then, a light pattern 129 is casted to the reaction substrate surface 122 to illuminate a selected set of microwells. This results in the production of acid 124 inside the selected set of microwells and consequently the removal of DMT protecting groups from the immobilized sequences on the substrate surface of the corresponding microwells. The synthesis cycle continues by completing monomer coupling, capping, and oxidation reactions. In this synthesis cycle, the monomer nucleotide would only be added to the immobilized sequences inside the selected set of the microwells. In the next synthesis cycle, another monomer nucleotide is added to the immobilized sequence inside another selected set of microwells. This cyclic process continues until all predetermined DNA sequences are synthesized. Chemistries and reagents including photogenerated reagents relating to parallel synthesis of DNA, peptide, and other biomolecules are described in Gao, X. et. al., Method and apparatus for chemical and biochemical reactions using photogenerated reagents, U.S. Pat. No. 6,426,184 B1 (2002) and Gao, X. et. al., Photogenerated reagents, U.S. Pat. No. 7,544,829 B2 (2009), which are incorporated herein by reference.

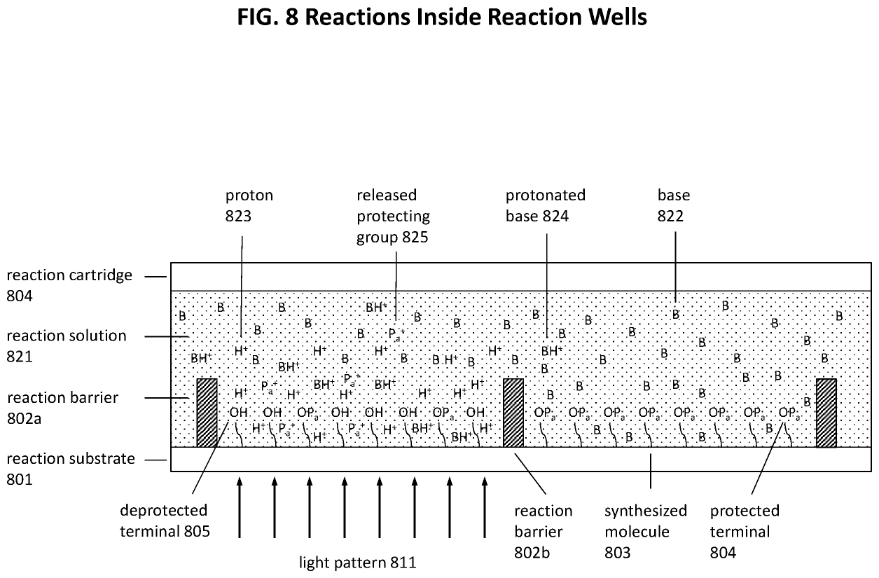

FIG. 8 schematically illustrates chemical compositions and reactions inside reaction microwells during a PAG based deblock reaction of DNA synthesis. The figure includes two reaction microwells with the left-side microwell being exposed to light and the right-side microwell not being exposed to light. In this exemplary embodiments, base molecules 822, as represented by B in the figure, are added into the deblock solution 821 in addition to PAG molecules, which are not explicitly shown in the figure. Without light exposure, synthesized molecules 803 in the right-side microwell remain protected by acid labile protecting groups at the terminals 804. In the figure, Pa stands for acid labile protecting group, which is DMT in DNA synthesis; —OPa represents DMT protected hydroxyl group. Upon light exposure, photoacid or proton 823 is produced, the DMT protecting groups are removed, and the ends of the synthesized molecules become deprotected terminals 805 inside the left-side microwell. In the figure, the proton 823 is represented by H⁺; the deprotected terminal 805 is a hydroxyl group as represented by OH; the released protecting group 825 is a cation as represented by Pa⁺; and the reaction product between a proton and a base is a protonated base 824 molecule as represented by BH⁺. The benefit of having the reaction barrier 802b between the two microwells is to prevent the near surface lateral diffusion of photogenerated acid or protons from the light exposed microwell into the unexposed microwell.

The usefulness of the base 822 has two folds. First, a background light is almost inevitable in any type of projector. The base is used to neutralize the photoacid that is produced in the unexposed microcell due to the background light. Second, the base is used to neutralize the extra photoacid in the exposed microwell and prevent the photoacid from diffusing over the top of the barrier 802b to the bottom of the unexposed microwells. Exemplary bases include but not limited to pyridine, trimethylamine, dimethylamine, methylamine, imidazole, benzimidazole, and histidine. The appropriate ratio between the base and PAG may vary depending on the strength of the base, quantum efficiency of the PAG, the quality of the projector in terms of background level and contrast ratio, the microwell design, and reactor design. In one embodiment the molar ratio between the base and PAG is below 0.01. In another embodiment the molar ratio between the base and PAG is below 0.05. In another embodiment the molar ratio between the base and PAG is below 0.10. In another embodiment the molar ratio between the base and PAG is below 0.15. In another embodiment the molar ratio between the base and PAG is below 0.20. In another embodiment the molar ratio between the base and PAG is below 0.50. In another embodiment the molar ratio between the base and PAG is below 0.70.

In some embodiment, one or more light absorbers are added to the deblock solution. The light absorber is used to limit the penetration depth of light into the exposed microwells so that photoacid would be mostly produced near the reaction substrate surface. This reduces the production of photoacid away from the substrate surface and reduces the chance for the photoacid from diffusing into the neighboring unexposed microwells. A suitable light absorber absorbs light at the wavelength of the projector used in the parallel synthesis. In some embodiments, active light absorbers including photosensitizers and photoinitiators are used. In some embodiments, passive light absorbers such as dyes are used. In some embodiments, a combination of active and passive light absorbers is used. Exemplary light absorbers include but not limited to Avobenzone, BLS 99-2, Martius yellow, Nitrofurazone, 2-nitrophenyl phenyl sulfide, quercetin, SpeedCure DETX, Speedcure CPTX, and SpeedCure EMK. The penetration depth can be defined in various ways that are consistent with specific considerations of the photochemical reactions. In one exemplary embodiment, the penetration depth is defined as the light travel distance in the deblock solution over which light intensity drops down by 50%. The penetration depth can be controlled by selecting appropriate light absorbers and by adjusting the concentrations of the light absorbers under the guidance of Beer-Lambert law. In one embodiment the penetration depth is controlled to be less than 10,000 micrometers. In another embodiment the penetration depth is controlled to be less than 1,000 micrometers. In another embodiment the penetration depth is controlled to be less than 100 micrometers. In another embodiment the penetration depth is controlled to be less than 10 micrometers. In another embodiment the penetration depth is controlled to be less than 1 micrometer.

### Synthesis Apparatus

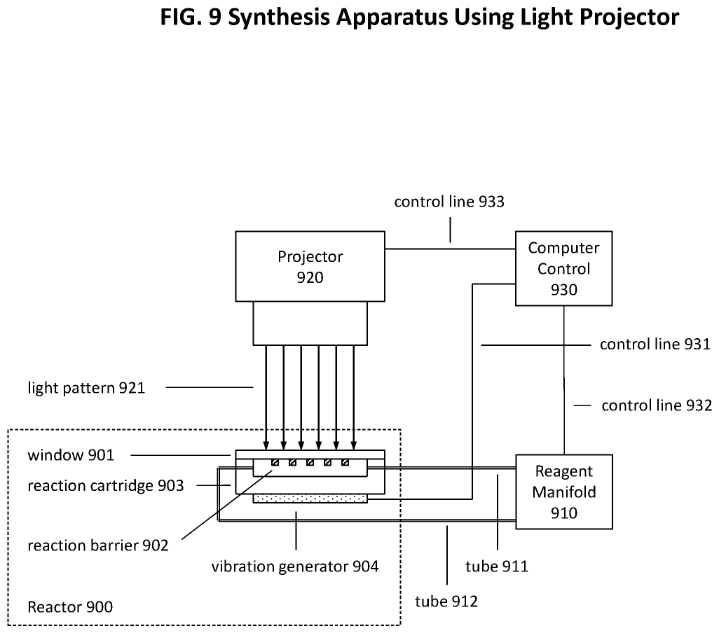

This invention includes a synthesis apparatus designed to perform parallel synthesis of biomolecules as well as formation of reaction barriers. FIG. 9 schematically illustrates an exemplary embodiment of the synthesis apparatus. The synthesis apparatus comprises four main subsystems including a reactor 900, a reagent manifold 910, a projector 920, and a computer control 930 to accomplish four functions including chemical reaction, reagent delivery, light projection, and system control, respectively. Some aspects of the synthesis apparatus were previously described in Gao, X. et. al., Method and apparatus for chemical and biochemical reactions using photogenerated reagents, U.S. Pat. No. 6,426,184 B1 (2002), which is incorporated herein by reference.

The reactor subsystem 900 consists of a transparent window 901 and a reaction cartridge 903. Inside surface of the transparent window 901 is the reaction substrate. The reaction cartridge 903 contains inlet and outlet ports for reagent delivery. In some embodiments, the reaction cartridge further comprises a vibration generator 904 attached to the backside of the cartridge. The vibration generator 904 is used to enhance fluid mixing inside the reactor 900 by inducing oscillatory displacement of the cartridge backside towards and away from the transparent window 901. The vibration generator 904 is a device selected from a group consists of solenoid vibration generator, offset weight motor, piezo transducer, and any other electrical, mechanical, and pneumatical devices that can produce mechanical vibrations.

The reagent manifold 910 performs standard reagent metering, delivery, circulation, and disposal. It consists of reagent containers, solenoid or pneumatic valves, metering valves, tubing, and process controllers (not shown in FIG. 9). The reagent manifold 910 also includes an inert gas handling system for solvent/solution transport and line purge. The design and construction of such a manifold are well known to those who are skilled in the art of fluid and/or gas handling. In many cases, commercial DNA/RNA, peptide, and other types of synthesizers can be used as the reagent manifold 910 of this invention.

The function of the projector 920 is to cast light beams or light patterns 921 for initiating photochemical reactions at predetermined locations on a substrate surface, which is the inside surface of the transparent window 901. Various types of projectors or optical projection systems can be used including but not limited to digital light projector (DLP) that operates based on light reflection from digital micromirror device (DMD), liquid crystal display (LCD) projector that operates based on light transmission through an LCD matrix, reflective LCD projector that operates based on light reflection from a reflective LCD matrix, and laser scanning module that operates based on laser beam reflection through two galvanometers. An exemplary projector is comprised of a light source, one or more optional filters, one or more condenser lenses, one or more reflectors or prisms, a digital micromirror device (DMD), a projection lens, and electronic controls. A suitable light source includes but not limited to light emitting diode (LED) of an appropriate wavelength, laser of an appropriate wavelength, and mercury lamp. The appropriate wavelength is chosen to match the activation wavelength of photoinitiators and/or photosensitizers used in the 3D printing resin compositions and the photogenerated reagents in the parallel biomolecule synthesis of this invention.

Computer control subsystem 930 coordinates the operations of reagent manifold 910, projector 920 and reactor 900. The computer control subsystem 930 consists of one or more computers, communication boards or devices, and software control programs.

Following is an exemplary stepwise process for parallel DNA synthesis. The computer control 930 sends commands through control line 932 to the reagent manifold 910 to inject 3D printing resin into reactor 900. The reagent manifold 910 executes the commands and delivers the resin through tubes 911 and 912 to the reactor 900. The computer control 930 then sends reaction barrier pattern data and exposure intensity and time parameters to projector 920. The projector 920 casts a light pattern of the reaction barrier at the intensity level and for the duration time as directed by the computer 930. Upon the light exposure, the 3D printing resin polymerizes and becomes microwell barriers 902 on the inside surface of the transparent window 901. Within individual microwells the window 901 surfaces constitute the substrates for parallel synthesis of DNA sequences. The computer 930 directs the reagent manifold 910 to carry out all necessary synthesis steps to couple spacer molecules to the substrates of all the microwells. Exemplary spacers include but not limited to spacer phosphoramidite 18 from Glen Research (USA) and a phosphoramidite nucleotide, which are terminated with acid labile dimethoxytrityl (DMT) protection groups. The computer 930 directs the reagent manifold 910 to inject a photoacid generator (PAG) solution into the reactor 900. The computer 930 sends a light pattern data and exposure intensity and time specifications to the projector 920. The projector 920 casts the light pattern 921 at the intensity level and for the duration time as specified. The light pattern 921 is composed of light spots illuminating on the first set of selected microwells. This results in the production of photoacid which in turn removes DMT protection groups from the spacer molecules in the corresponding microwells. The computer 930 then directs the reagent manifold 910 to carry out all necessary synthesis steps to couple the first nucleotide to the substrates of the first set of selected microwells. The cycle of PAG injection, light illumination, and coupling reaction is carried out for the second nucleotide in the second set of selected microwells. The process is repeated until the synthesis of all predetermined DNA sequences is completed. During the synthesis process when the reactor 900 is flushed with a new reagent, whether it is a wash solution, a PGA solution, a monomer solution, a capping solution, or an oxidation solution, vibration generator 904 is turned on for a specific period of time by the computer 930 through control line 931. This helps solution mixing and/or removing inside the microwells.

The synthesis apparatus of this invention can be applied in a high-throughput production process. In an exemplary embodiment, the reactor 900 is designed to hold a large window 901 which is the reaction substrate. In another exemplary embodiment, the reactor 900 is designed to hold multiple windows 901 which are arranged in 1-deminsional or 2-deminsional tile arrays. In one exemplary embodiment, the projector 920 is mounted to a motorized x-y translation stage to cast light patterns 921 to all regions of the substrate surface in a stepwise tiling fashion. In another exemplary embodiment, the reactor 900 is mounted to a motorized x-y translation stage to enable the exposure of all regions of the substate surface to the light patterns 921 in a stepwise tiling fashion. In most cases, each light exposure takes up between a fraction of a second and a few seconds depending the projector light intensity and PAG composition in the deblock solution while the combined time for the rest of reaction steps of a synthesis cycle takes up about minutes. Therefore, the tiling exposures would not significantly increase the overall synthesis time.

### Post-Synthesis Applications

The applications for the synthesized molecules are categorized as on-chip and off-chip, respectively. Exemplary on-chip applications include DNA and RNA hybridizations on DNA and RNA arrays, aptamer screening on DNA and chimeric DNA arrays, and protein binding on peptide arrays. Off-chip applications are based on the use of the molecular products cleaved from the substate surface. Exemplary applications include gene assembly, small interfering RNA (siRNA) library preparation, sequence capture for targeted sequencing, CRISPR/Cas9 guide RNA library preparation, protein coding and antibody library preparation, and fluorescence in situ hybridization (FISH) application. Methods of parallel chemical synthesis and cleavage of DNA molecules have been described by X. Gao et al. in Array oligomer synthesis and use (2002) US20070059692A1 which is hereby incorporated by reference in its entirety.

As compared to conventional microfabrication of barriers or reaction structures, the in-situ reaction barrier construction of the present invention has a significant advantage in facilitating parallel chemical synthesis on large substrates and/or in large scales in terms of manufacturing cost as well as process simplicity. Conventional microfabrication involves expensive equipment and materials and is cost effective only to produce miniaturized devices of fixed designs. However, application requirement for parallel synthesis varies. Sometimes, the requirement is to produce many products at relatively large amount. Sometimes, the requirement is to produce many batches of products in parallel with each batch containing multiple products. These applications often require large sized devices (reaction wells) that require large substrate surface areas to produce proportionally large molar quantities of products. The in-situ reaction barrier construction of the present invention has the flexibility to produce reaction-well designs of any well size, shape and density and has no substrate size limitation.

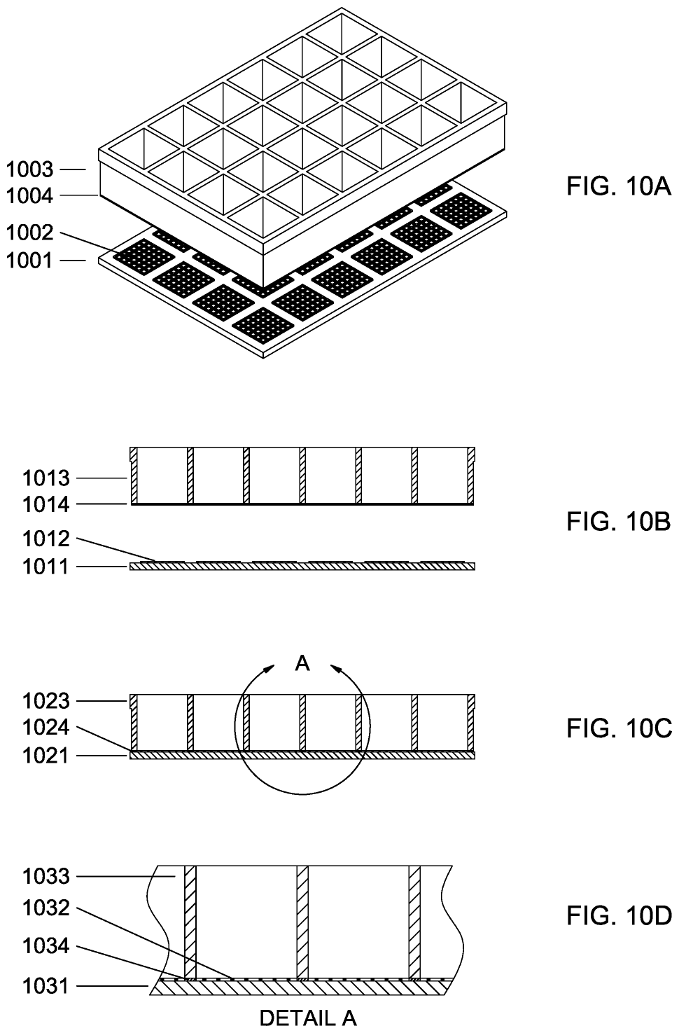

FIG. 10A through FIG. 10D schematically illustrate an exemplary embodiment of using through-hole plate 1003, 1013, 1023, and 1033 to isolate subarrays 1002, 1012, and 1032 for post-synthesis applications. The through-hole titer plate 1003, 1013, 1023, and 1033 is made of a plastic or any other appropriate material including but not limited to rubber, metal, glass, and ceramic. In some embodiment, the lower surface of the through-hole titer plate 1003, 1013, 1023, and 1033 has a gasket 1004, 1014, 1024, and 1034. The gasket is made of materials selected from a group consisting of rubber, silicone, elastomer, and adhesive. Subarray 1002 and 1012 arrangement on substrate plate 1001 and 1011 is designed to match that of through-holes 1005 and 1015 in the through-hole titer plate 1003 and 1013. When the through-hole titer plate and substrate plate are assembled titer wells 1025 and 1035 are formed with each well having a subarray 1032 at the bottom as shown FIG. 10C and FIG. 10D. The titer wells 1025 and 1035 are isolated from each other by the gasket 1024 and 1034. The size and the design of the through-hole titer plate can be made based standard format as well as custom format. The standard format has 6, 12, 24, 48, 96, 384, and 1,536 holes, respectively, arranged in a 2:3 rectangular matrix. In some embodiments the top surface of the through-hole plate 1003 can be sealed by using microplate sealing films or adhesive PCR plate foils.

The titer plate assembly shown in FIG. 10C and FIG. 10D has many high-throughput applications when it is used in conjunction with fluidic handling robots. In assay applications, each titer well 1025 and 1035 can process one biological sample. One exemplary application is high-throughput genotyping by hybridization assays using DNA subarrays 1032 synthesized by the parallel DNA synthesis of this invention. Another exemplary application is high-throughput antibody screening assays using peptide subarrays 1032 synthesized by the parallel peptide synthesis of this invention.

In a gene assembly application, each subarray 1032 is designed to contain all oligo DNA sequences required to assemble a gene or a fragment of a gene. In one embodiment the length of the gene fragment is between 100 and 10,000. In another embodiment the length of the gene fragment is between 100 and 2,000. In another embodiment the length of the gene fragment is between 200 and 2,000. In another embodiment the length of the gene fragment is between 400 and 2,000. In yet another embodiment the length of the gene fragment is between 400 and 1,000. During an exemplary gene assembly process, DNA oligo sequences are synthesized on the substrate plate; a through-hole titer plate is attached to the substrate plate to isolate individual subarrays; a cleavage solution is pipetted into all the titer wells to cleave the DNA oligo sequences from the substrate surface; an enzyme solution for ligation or PCR assembly is added to all the titer wells; ligation or PCR assembly reactions are performed and individual genes or gene fragments are produced in individual titer well. In an alternative embodiment, after the synthesized DNA oligos are cleaved from the substrate surface, the oligo mixture solutions from individual titer wells 1025 are moved into individual tube of one or more PCR plates where the remaining processes of ligation or PCR assembly, error removal, and purification are performed.

### Other Applications

Various modifications and variations of this invention are possible. In an exemplary embodiment, the reaction wells and/or 3D structures are first produced by using material jetting or Inkjet 3D printing in which a polymer resin is delivered to a substrate surface through an inkjet and then immediately cured using a UV light (Gebhardt, A., Understanding Additive Manufacturing. Hanser. ISBN 978-3-446-42552-1, (2011)). This is followed by inkjet based parallel synthesis of desired molecules including DNA sequences.

Obviously, many other modifications and variations of this invention are possible in the light of the above teachings. It is therefore to be understood that within the scope of the appended claims the invention may be practiced otherwise than as specifically described.

### EXAMPLES

### Example I—Photoacid Deblock Reactions on Barrier Containing and Open Surfaces

This example is an experimental demonstration of barrier confinement of near surface molecular diffusion.

The parallel synthesis apparatus uses an in-house fabricated reaction cartridge, an Expedite 8909 DNA Synthesizer (USA), a custom-build DLP projector (USA), and a computer control system. The projector is equipped with a 405 nm LED light source, has an optical output of 0.7 W, has a resolution of 1,024×768, and has a pixel pitch of 28 micrometers at focal plane.

Most DNA synthesis reagents used in this experiment were purchased from regular DNA synthesis reagent suppliers including Sigma-Aldrich (USA) and Glen Research (USA). The preparation of the PAG deblock solution is described in Zhou, X. et al. Microfluidic picoarray synthesis of oligodeoxynucleotides and simultaneously assembling of multiple DNA sequences. Nucleic Acids Research 32, 5409-5417 (2004)

Microscope glass slides (25 mm×75 mm, from Thermo Fisher Scientific (USA)) were used as the synthesis substrate. The glass slides were treated in high temperature at 420° C. for 2 hours, derivatized in 0.5% v/v 3-acrylamidopropyltrimethoxysilane toluene solution at room temperature for 24 hours, washed sequentially with toluene, methyl alcohol, and water, and then heated at 140° C. for 20 minutes. A derivatized glass slide was mounted to a reaction cartridge ready to be used for synthesis reaction.

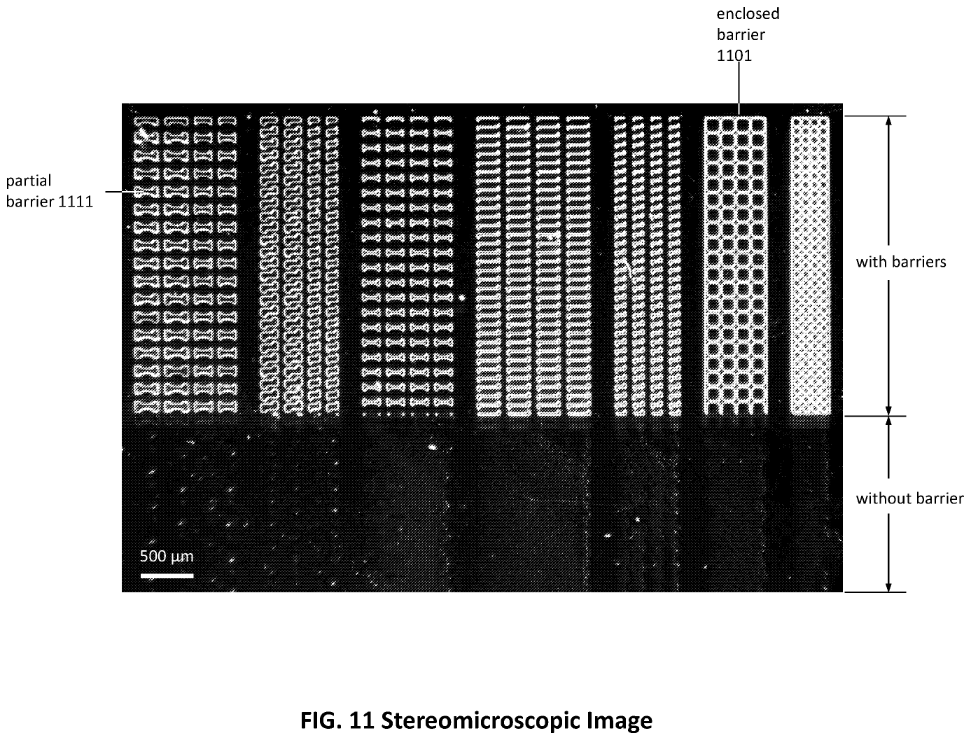

Reaction barriers on the substrate surface were made from SainSmart Rapid UV 405 nm 3D Printing Resin (USA). To construct the reaction barriers, the resin was injected into the reactor; a light pattern of reaction barriers was projected to the substrate surface at an irradiance of 10 mW/cm 2 for 400 milliseconds; the remaining resin was washed out by acetonitrile. FIG. 11 shows a stereomicroscopic image of the reaction barriers made in this experiment. The image was produced by using SM-1 stereo microscope (USA). Various barrier shapes were made in this experiment. Enclosed barriers 1101 encircles substrate surface into isolated microwells. Partial barriers 1111 only block near surface fluid flow and/or diffusion in certain directions. In FIG. 11, reaction barriers are made in the upper half of the substrate surface but not in the lower half of the surface.

Parallel synthesis started with the coupling of a dT nucleotide to all open regions of the substrate surface using standard phosphoramidite synthesis protocols with minor modifications. The dT nucleotide was terminated with DMT protecting groups. A PAG deblock solution was then sent into the reactor. A light pattern was projected to the reaction substrate surface to illuminate a selected number of microwells and surface regions at an irradiance of 80 mW/cm 2 for 1 second. The deblock solution was kept static within the reactor for 20 seconds before being washed away by acetonitrile. Biotin-dT was then coupled to the substrate surface. The post-synthesis deprotection of the surface oligonucleotide molecules was done by keeping the glass substrate in 50% v/v ethylenediamine in anhydrous alcohol solution at room temperature for overnight.

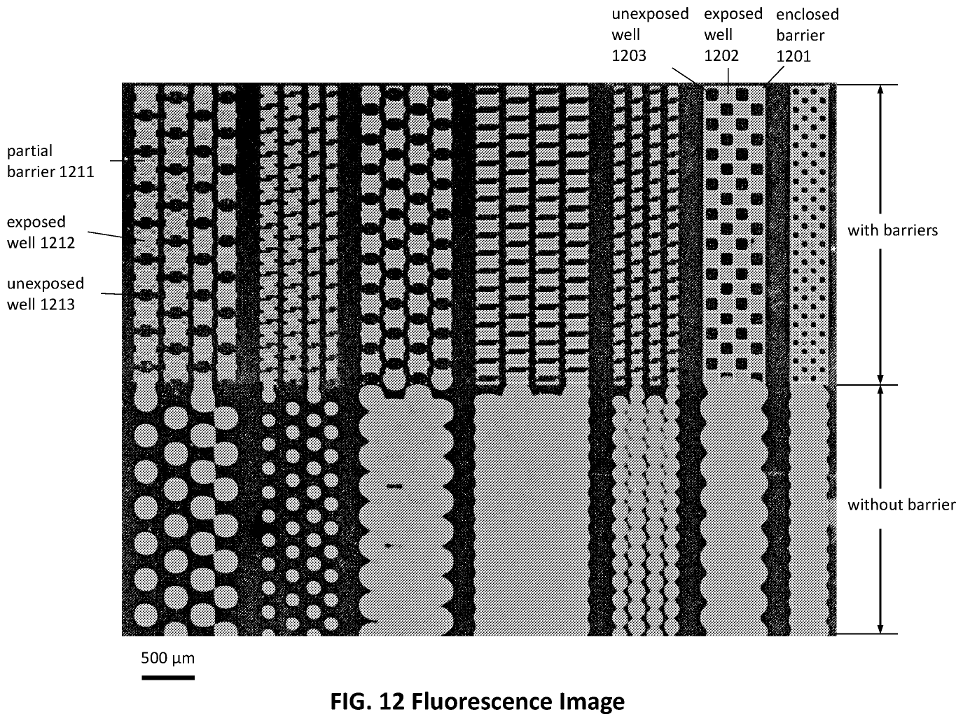

To reveal the surface areas on which the above photoacid deblock reactions took place the surface biotin molecules were stained with fluorescence molecules. A streptavidin solution (10 ng streptavidin in 1,000 microliter 1M NaCl buffer) was circulated through the reactor at room temperature for 30 minutes. A fluorescence solution (4 nM Alexa Fluor 647 labeled, and biotinylated dT in 1M NaCl buffer) was circulated through the reactor at room temperature for 30 minutes. A fluorescence image of the glass slide was produced by using Molecular Devices Axon GenePix 400013 microarray scanner (USA) and is shown in FIG. 12. This fluorescence image was collected from the same surface area as that shown in FIG. 11. During the photoacid deblock step, the light pattern was designed to match the substrate regions bounded by the reaction barriers and the same light pattern was applied to both the substrate areas with and without reaction barriers. In FIG. 12 the fluorescence signals mark the surface regions where photoacid reached and deblock reactions took place. With the reaction barriers the deblock reactions were confined within the barrier bounded regions, as shown in the upper half of FIG. 12. Without the reaction barriers the deblock reactions extended considerably beyond the light exposed regions, as shown in the lower half of FIG. 12. This data demonstrates the effectiveness of the reaction barriers for limiting the near surface photoacid diffusion.

We claim:

1. A method of parallel chemical synthesis on a solid surface comprising:
(a) forming barrier structures on a solid surface by photopolymerization to produce barrier confined regions; and
(b) conducting chemical synthesis in the barrier confined regions of the solid surface.

2. A reaction apparatus for performing parallel chemical synthesis on a solid surface comprising:
(a) a solid substrate,
(b) a reagent manifold for delivery of 3D printing resins and synthesis reagents,
(c) a projector, and
(d) a computer control system.

3. The reaction apparatus of claim 2 wherein the solid substrate is a carrier of in-situ barrier construction and biomolecule synthesis.

4. The reaction apparatus of claim 2 further comprising a reactor cartridge.

5. The reaction apparatus of claim 4 wherein the reactor cartridge is a vibration generator.
